(19) United States
(12) Patent Application Publication
(10) Pub. No.: US 2021/0036529 A1
(43) Pub. Date: Feb. 4, 2021

(54) Apparatus for Charging a Personal Mobile Device

(71) Applicant: ESC Digital Media Ltd, Surrey (GB)

(72) Inventor: Ian Rees, Surrey (GB)

(21) Appl. No.: 16/968,280

(22) PCT Filed: Feb. 7, 2019
(86) PCT No.: PCT/GB2019/000022

§ 371 Date: Aug. 7, 2020

(30) Foreign Application Priority Data
Feb. 7, 2018 (GB) 1801965.3

(51) Int. Cl. H02J 7/00; H02J 7/35; H02J 7/02; H02J 50/10; H04R 3/00; H04R 1/02; H04B 7/145; H04W 88/04

(52) U.S. Cl. CPC H02J 7/0045; H02J 7/35; H02J 7/02; H02J 50/10; H04R 2420/07; H04R 1/028; H04B 7/145; H04W 88/04; H04R 3/00

(57) ABSTRACT

An apparatus for charging a personal mobile device, comprising an enclosure, one or more photovoltaics on at least one outer side of the enclosure, one or more heat exchangers on at least one outer side of the enclosure, an opening in at least one side of the enclosure, leading to a recess within the enclosure for stowing a personal mobile device and one or more electrical power outputs within the enclosure arranged to provide electrical power charge to the personal mobile device. The photovoltaics provide the electrical power to the electrical power outputs, and the enclosure is arranged to protect the personal mobile device from direct exposure to the weather elements during the time it is stowed or is being charged.

### FIELD OF THE INVENTION

The present disclosure relates to an apparatus for charging a personal mobile device. More specifically it relates to a charging apparatus that is itself portable and which provides stowing facility, protection from the elements and security for the personal mobile device during the charging process.

### BACKGROUND TO THE INVENTION

Personal mobile devices such as mobile (cellular) phones, smart phones, tablets, and smart watches, or many other personal electronic items for gaming, video, audio or photography have become a major part of daily live.

As electronic items these devices require electrical power to operate and are normally equipped with an internal rechargeable battery. Manufacturers of these devices have had to compromise on the devices' form factor and the size of their internal battery. This means that the batteries offer a limited amount of power supply time, which may range from a few minutes to few hours and rarely to a full day. The power supply time depends on the type of device and amount of active operational time. Consumers have reluctantly accepted these limitations and have tried to find ways to keep their devices charged. It is not a rare view to see people running around with mains chargers and cables scouting for a mains power socket, or using bulky external battery units to recharge their devices. Charging these devices overnight for a full next day use is not sufficient anymore. Furthermore, as some personal mobile devices are now being used even more extensively, for example for entertainment, reading, internet navigating, social media, or even working while away from the office, a power supply to keep the batteries of these devices charged is required at a location of convenience for the user. As the user may be outdoors or indoors and away from a mains power socket, the inventors have identified as a solution a convenient portable re-charging apparatus for personal mobile devices that is safe, convenient and can be used in different environments, and which can further provide stowing facility, protection from the elements and security for the personal mobile device during the charging process. For the purpose of this invention the terms apparatus and charger are interchangeable and refer to each other. Similarly the term device refers to any personal mobile device or electronic device or electronic items for timekeeping, gaming, video, audio, photography or the like.

### SUMMARY OF THE INVENTION

According to a first aspect of the invention there is provided an apparatus for charging electrical vehicles, the apparatus comprising:
an apparatus for charging a personal mobile device, comprising:
an enclosure,
one or more photovoltaic solar panels on at least one outer side of the enclosure,
one or more heat exchangers on at least one outer side of the enclosure,
an opening in at least one side of the enclosure, leading to a recess within the enclosure for stowing a personal mobile device,
one or more electrical power outputs within the enclosure arranged to provide electrical power charge to the personal mobile device,
wherein the photovoltaics provide the electrical power to the electrical power outputs, and
wherein the enclosure is arranged to protect the personal mobile device from direct exposure to the weather elements during the time it is stowed or is being charged.

Preferably, the apparatus may further comprise an internal rechargeable battery.

Preferably, the apparatus may further comprise a small wind power generator.

Preferably, the apparatus may further comprise one or more electrical power inputs.

Preferably, the internal battery may be arranged to be chargeable from one of or a combination of the solar power source, electrical power inputs, wind power etc.

Preferably one of the electrical power inputs is connectable to the mains power.

Preferably one of the other electrical power inputs may be connectable to an external portable battery.

Preferably the heat exchanger may be passive and/or comprise cooling fans.

Preferably, the apparatus may further comprise one or more slots to dock the personal mobile device in an upright position to facilitate viewing of the personal mobile device's screen whilst charging.

Preferably, the apparatus may further comprise a thermoelectric cooling means arranged to cool the inside of the enclosure and/or arranged to cool a drink container placed inside the enclosure.

Preferably one of the charging outputs is a low voltage power port and/or a communications port, such as Universal Serial Bus USB or other proprietary similar ports, e.g. Apple's Lighting port.

Preferably one of the charging outputs is a low voltage cabled power plug and/or communications port, such as Universal Serial Bus USB or other proprietary similar plug e.g. Apple's Lighting port.

Preferably one of the charging outputs is an inductive wireless charging output.

Preferably, the apparatus may further comprise an audio input and/or speakers.

Preferably, the audio input is an audio jack socket or additionally or alternatively is a wireless communication protocol, such as Bluetooth, IEEE 802.15.1.

Preferably, the apparatus may further comprise means to amplify two-way WiFi, IEEE 802.11 communication signals.

Preferably, the apparatus may further comprise ethernet input and output ports and means to transmit and receive WiFi, IEEE 802.11 signals, i.e., acting as a hotspot.

Preferably, the photovoltaic solar panels are switchable manually or via circuitry controlling means, so that they have multiple purpose of charging: charging the internal battery only, charging the mobile device only, or charging both the internal battery and mobile device.

Preferably, the apparatus may further comprise means that identify when the mobile device is connected to the apparatus via wires or wirelessly, for charge and or data connection.

Preferably, the apparatus may further comprise means to redirect the power of the photovoltaic solar panels from the charging of the internal battery to charging directly the mobile device, when the mobile device is identified as being connected to the apparatus, and then to redirected back into charging the internal battery when the mobile device is disconnected, and further may comprise means to add the power of the solar panel to the power of the internal batteries and boost the output to o30W or more, suitable for rapid charging two or more mobile devices at the same time.

Preferably, the apparatus may further comprise wireless charging outputs that can throttle the power to protect against overtemperature of the mobile device battery, wherein the wireless chargers are fully tested to the QI standard, and comprise means of controlling against foreign metal bodies, overheating, overcharging and overcurrents; and further comprise means that communicate with wireless enabled mobile devices.

Preferably, the apparatus may be capable of supporting power of 15W or more for rapid charge and will be capable of charging up to 6 mobile devices, such as iPhone™ type phones from flat; the power capacity of the internal battery may be 20Ah, 25Ah, 30Ah or over 50Ah and support charging up to 6 mobile devices, such as iPhone™ type phones from flat.

Preferably, the internal battery may be super safe with no thermal over run or explosive properties and will have little to no memory so that may be charged and discharged 4000 times or more and are very resistant to temperature variations; the internal battery may have an efficiency of 97 percent efficient or more and will create very little heat.

### BRIEF DESCRIPTION OF THE DRAWINGS

The invention will now be described by way of example only with reference to the accompanying diagrammatic drawings in which:

FIG. 1 illustrates a perspective view of an apparatus for charging a personal mobile device while stowed in a recess of the apparatus, in accordance with the invention;

FIG. 2 illustrates a top view of the apparatus;

FIG. 3 illustrates a side view of the apparatus;

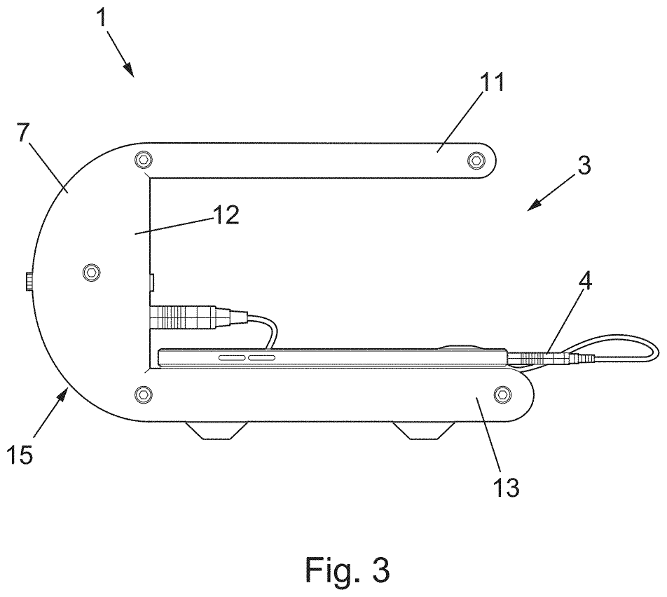

FIG. 4 illustrates a back view of the apparatus;

FIG. 5 illustrates the apparatus being used to charge a personal mobile device in an outdoor environment;

FIG. 6 illustrates an additional embodiment of the invention comprising a slot arranged to dock the personal mobile device in an upright viewing position, and further comprising a wireless charging area in the recess of the apparatus.

### DETAILED DESCRIPTION OF THE INVENTION

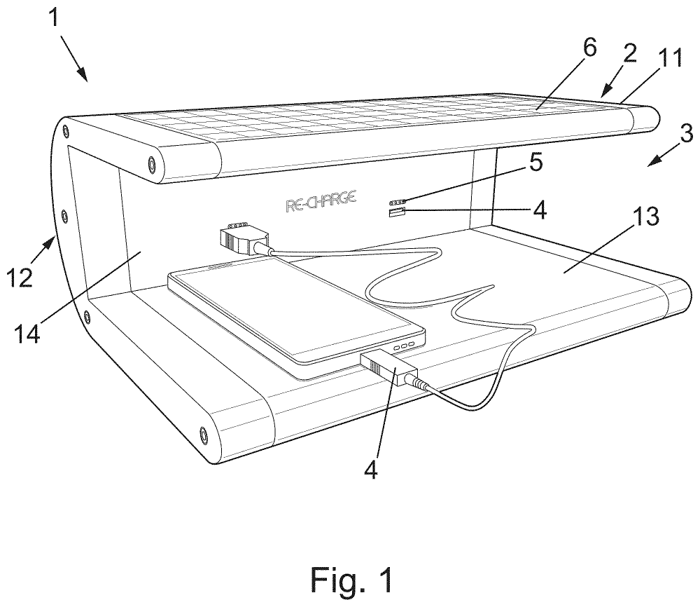

An apparatus 1 for charging a personal mobile device in accordance with a first aspect of the invention is shown in FIG. 1. The apparatus comprises an enclosure 2. The enclosure 2 has an opening 3 in at least one side of the enclosure 2, leading to a recess within the enclosure 2 for stowing the personal mobile device.

Within the enclosure 2 there is one or more electrical power outputs 4 arranged to provide electrical power charge to the personal mobile device, which can be a mobile (cellular) phone, smart phone, tablet, smart watch, or can be any other personal electronic item for gaming, video, audio, photography, etc.

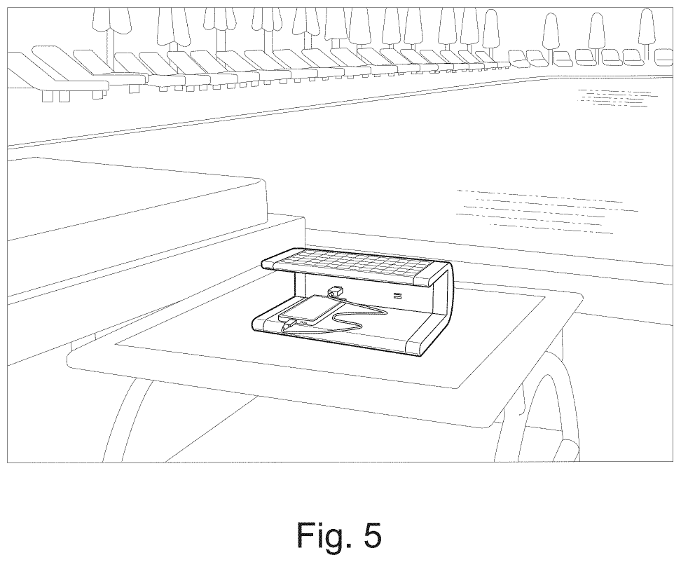

The enclosure 3 is arranged to protect the personal mobile device from direct exposure to the weather elements during the time the personal mobile device is stowed or is being charged. Weather elements are understood to be rain, direct sunlight, wind, humidity, etc. The apparatus 1 is arranged to be moveable and placeable outdoors, for example at the beach or by a swimming pool. As such it offers protection from water splashes, wind, sand, etc., as seen e.g. in FIG. 5.

Alternatively or additionally the enclosure 3 is arranged to protect the personal mobile device from being stolen, i.e. it offers means to secure the personal mobile device. To achieve this, the opening 3 of the apparatus 1 may have a lockable door that prevents access to the enclosure 2 and thus prevents access to the personal mobile device. Alternatively, the enclosure 2 may comprise lockable clamping means or similar lockable fastening means to prevent unauthorised removal of the personal mobile device.

The apparatus 1 may comprise one or more indicators 5 such as LED lights or LCD displays to indicate the charging status of the personal mobile device connected to one of the electrical power outputs 4. The indicators 5 may also be arranged to display additional information such as weather, news, music etc., or further be part of a smart device, which may be for example an android software based smart device, and thus offer all the facilities of such a smart device.

The electrical power outputs 4 are low voltage power ports and may also provide the features of a communications port, such as Universal Serial Bus USB port or other proprietary similar ports such as Apple's Lighting port.

Alternatively or additionally the electrical power outputs 4 may be a low voltage cabled power plug and may also provide the features of a communications port, such as Universal Serial Bus USB port or other proprietary similar ports such as Apple's Lighting port.

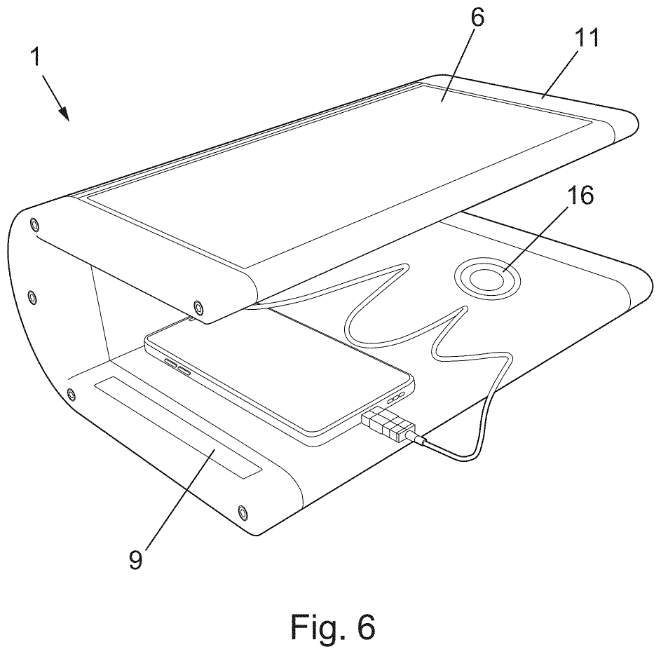

Alternatively or additionally one or more of the electrical power outputs 4 may be inductive wireless charging outputs 16, as shown e.g. in FIG. 6.

The apparatus may be arranged to charge more than one personal mobile device or the like at a time.

The apparatus comprises one or more photovoltaics 6, or commonly referred to as solar panels, on at least one outer side of the enclosure. The one or more photovoltaics 6 are visible e.g. in FIGS. 1 and 5. The photovoltaics 6 provide the electrical power to the electrical power outputs 4.

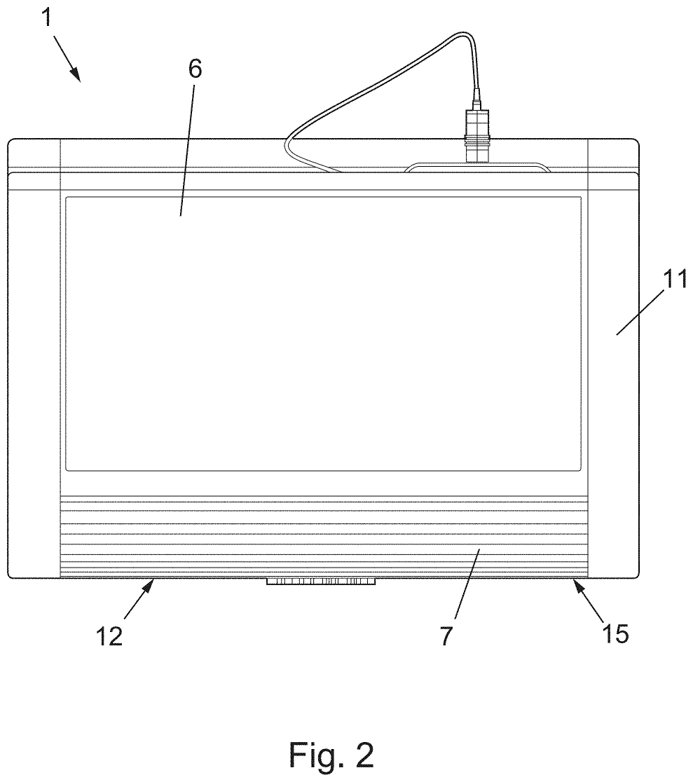

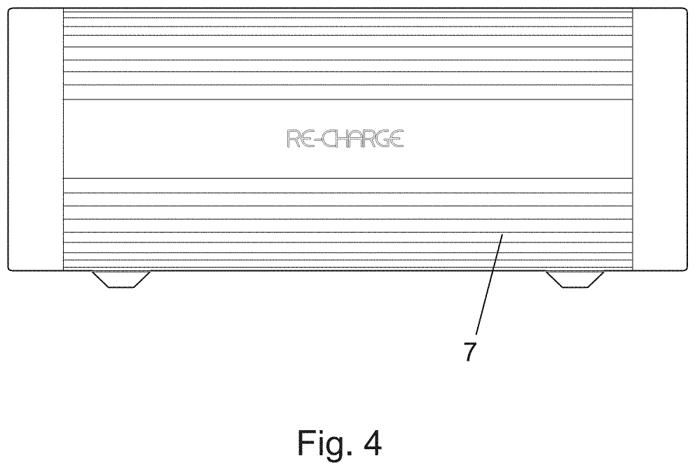

The apparatus further comprises one or more heat exchangers 7 on at least one outer side of the enclosure 2. The one or more heat exchangers 7 are visible e.g. in FIGS. 2 and 4. The heat exchangers 7 may be passive such as extrusions, fins, gaps or openings, additionally or alternatively the heat exchangers 7 may be arranged to have active cooling and comprises cooling fans.

The one or more photovoltaics 6 and the one or more heat exchangers 7 may be arranged on different sides of the enclosure 2, or may be arranged on all sides of the enclosure 2 in an alternate arrangement of the two.

The apparatus 1 further comprises an internal rechargeable battery.

The apparatus 1, additionally or alternatively comprises a small wind power generator.

The apparatus 1, additionally or alternatively comprises one or more electrical power inputs.

The internal battery is arranged to be chargeable from one of or a combination of the photovoltaics 6 solar power source, electrical power inputs, wind power generator, etc.

The electrical power inputs are arranged to be connectable to the mains power and or to an external portable battery, also known as power packs.

The apparatus 1 may further comprise a thermoelectric cooling means arranged to cool the inside of the enclosure 2 and/or arranged to cool a drink container placed inside the enclosure 2.

As better seen in FIG. 6, the apparatus 1 may further comprise one or more slots 9 to dock the personal mobile device in an upright position to facilitate viewing of the personal mobile device's screen whilst charging.

The apparatus 1 may further comprise an audio input and/or speakers for connecting to the audio port of the personal mobile device, thus providing the user with means to listen to music or sound. The audio input may be an audio jack socket or plug, or additionally or alternatively is a wireless communication protocol, such as Bluetooth, IEEE 802.15.1.

The apparatus 1 may further comprise means to amplify two-way WiFi, IEEE 802.11 communication signals. As such the apparatus 1 can pick up a weak WiFi signal coming e.g. from router positioned at a distance from the personal mobile device that would otherwise provide an unsuitable signal, and similarly broadcast a stronger signal back to the WiFi router.

The apparatus of claim 1, may additionally or alternatively comprise ethernet input and output ports and means to transmit and receive WiFi, IEEE 802.11 signals, i.e., acting as a hotspot.

All of the electronics of the various features of the apparatus 1, including the electrical power outputs are powered directly from one of or a combination of the photovoltaics solar power source, electrical power inputs, wind power generator, etc; or indirectly from the above, i.e. via the internal battery charged from one of or a combination of the photovoltaics solar power source, electrical power inputs, wind power generator, etc.

The enclosure 2 of the apparatus 1 may be any shape and size that comprises an opening 3 in at least one side of the enclosure, leading to a recess within the enclosure for stowing a personal mobile device. The enclosure may be round, partially round, box shaped, angular etc. In some variations the enclosure may be a sphere, a spheroid, a cylinder, a pyramid, a cone, a rectangular prism, a multiangular prism, or any three dimensional combination of the above. For description purposes, the apparatus shown in FIG. 1 is a rectangular prism having a top panel 11, a back panel 12 and a bottom panel 13. In the embodiment of FIG. 1 the bottom panel 13 is the recess of the enclosure 2 where the personal mobile devices are stowed.

In the embodiment of FIG. 1 the opening 3 is located where otherwise a front panel and two side panels would be located to complete the shape of a regular rectangular prism.

In the embodiment of FIG. 1 the back panel 12 has a flat inner side 14 facing the opening 3 of the enclosure and a curved outer side 15. The electrical power outputs 4 and indicators 5 are located on the flat inner side 14 of the back panel 12.

In the embodiment of FIG. 1, the photovoltaics 6 are located on the top panel 11.

In the embodiment of FIG. 1, the heat exchangers 7 are located on the curved outer side 15 of the back panel 12.

The inductive wireless charging outputs 16 and the stowing location of the personal mobile device are located on the recess of the enclosure 2, i.e. on an inner side of bottom panel 13.

In embodiments with lockable doors that prevents access to the enclosure 2 and thus prevents access to the personal mobile device, the lockable doors would be located at the opening 3. Alternatively, the enclosure 2 may comprise lockable clamping means or similar lockable fastening means to prevent unauthorised removal of the personal mobile device. These lockable fastening means could be located within the enclosure 2.

The slot 9 for docking the personal mobile device in an upright position to facilitate viewing of the personal mobile device's screen whilst charging may be located on the inner side of bottom panel 13, as seen in FIG. 6.

In further embodiments, the photovoltaic solar panels are switchable manually or via circuitry controlling means, so that they have multiple purpose of charging: charging the internal battery only, charging the mobile device only, or charging both the internal battery and mobile device.

The apparatus may further comprise means that identify when the mobile device is connected to the apparatus via wires or wirelessly, for charge and or data connection.

The apparatus may further comprise means to redirect the power of the photovoltaic solar panels from the charging of the internal battery to charging directly the mobile device, when the mobile device is identified as being connected to the apparatus, and then to redirected back into charging the internal battery when the mobile device is disconnected, and further may comprise means to add the power of the solar panel to the power of the internal batteries and boost the output to o30W or more, suitable for rapid charging two or more mobile devices at the same time.

The apparatus may further comprise wireless charging outputs that can throttle, increase and decrease, the power to protect against overtemperature of the mobile device battery, wherein the wireless chargers are fully tested to the QI standard, and comprise means of controlling against foreign metal bodies, overheating, overcharging and overcurrents; and further comprise means that communicate with wireless enabled mobile devices.

The apparatus may be capable of supporting power of 15W or more for rapid charge and will be capable of charging up to 6 mobile devices, such as iPhone™ type phones from flat; the power capacity of the internal battery may be 20Ah, 25Ah, 30Ah or over 50Ah and support charging up to 6 mobile devices, such as iPhone™ type phones from flat.

The internal battery may be super safe with no thermal over run or explosive properties and will have little to no memory so that may be charged and discharged 4000 times or more and are very resistant to temperature variations; the internal battery may have an efficiency of 97 percent efficient or more and will create very little heat.

Other variations and modifications will be apparent to the skilled person. Such variations and modifications may involve equivalent and other features which are already known and which may be used instead of, or in addition to, features described herein.

Features that are described in the context of separate embodiments may be provided in combination in a single embodiment. Conversely, features which are described in the context of a single embodiment may also be provided separately or in any suitable sub-combination.

It should be noted that the term “comprising” does not exclude other elements, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. An apparatus for charging a personal mobile device, comprising:
an enclosure,
one or more photovoltaics on at least one outer side of the enclosure,
one or more heat exchangers on at least one outer side of the enclosure,
an opening in at least one side of the enclosure, leading to a recess within the enclosure for stowing a personal mobile device,
one or more electrical power outputs within the enclosure arranged to provide electrical power charge to the personal mobile device,
wherein the photovoltaics provide the electrical power to the electrical power outputs, and
wherein the enclosure is arranged to protect the personal mobile device from direct exposure to the weather elements during the time it is stowed or is being charged.

2. The apparatus of claim 1, further comprising an internal rechargeable battery.

3. The apparatus of claim 1, additionally comprising a small wind power generator.

4. The apparatus of claim 1, additionally comprising one or more electrical power inputs.

5. The apparatus of claim 1, wherein the internal battery is arranged to be chargeable from one of or a combination of the solar power source, electrical power inputs, wind power etc.

6. The apparatus of claim 4, wherein one of the electrical power inputs is connectable to the mains power.

7. The apparatus of claim 4, wherein one of the other electrical power inputs is connectable to an external portable battery.

8. The apparatus of claim 1, wherein the heat exchanger is passive and/or comprises cooling fans.

9. The apparatus of claim 1, further comprising one or more slots to dock the personal mobile device in an upright position to facilitate viewing of the personal mobile device's screen whilst charging.

10. The apparatus of claim 1, further comprising a thermoelectric cooling means arranged to cool the inside of the enclosure and/or arranged to cool a drink container placed inside the enclosure.

11. The apparatus of claim 1, wherein one of the electrical power outputs is low voltage power port and/or communications port, such as Universal Serial Bus USB or other proprietary similar ports.

12. The apparatus of claim 1, wherein one of the electrical power outputs is low voltage cabled power plug and/or communications port, such as Universal Serial Bus USB or other proprietary similar plug.

13. The apparatus of claim 1, wherein one of the electrical power outputs is an inductive wireless charging output.

14. The apparatus of claim 1, further comprising an audio input and/or speakers.

15. The apparatus of claim 14, wherein the audio input is an audio jack socket or additionally or alternatively is a wireless communication protocol, such as Bluetooth, IEEE 802.15.1.

16. The apparatus of claim 1, wherein the apparatus comprises means to amplify two-way WiFi, IEEE 802.11 communication signals.

17. The apparatus of claim 1, wherein the apparatus comprises ethernet input and output ports and means to transmit and receive WiFi, IEEE 802.11 signals acting as a hotspot.
